(19) United States
(12) Patent Application Publication
(10) Pub. No.: US 2021/0319482 A1
(43) Pub. Date: Oct. 14, 2021

(54) INTERACTIVE, IMAGE-BASED COLLECTIBLE PRODUCT ANALYSIS SYSTEMS AND METHODS

(71) Applicant: Jeff DIXON, St. George, UT (US)

(72) Inventor: Jeff DIXON, St. George, UT (US)

(21) Appl. No.: 16/842,759

(22) Filed: Apr. 8, 2020

(51) Int. Cl. G06Q 30/02; G06N 20/00; G06Q 30/06; G06K 19/16

(52) U.S. Cl. CPC G06Q 30/0282; G06K 19/16; G06Q 30/0627; G06N 20/00

(57) ABSTRACT

Interactive, image-based collectible product analysis systems and methods are provided herein. An example method can include receiving, from a user device of a user, a grading request to obtain a grade for a collectible product having a first surface and a second surface, the grading request including a first image of the first surface and a second image of a second surface; determining the grade for the collectible product; generating grading indicia for the collectible product that includes the grade; causing the grading indicia to be mailed to the user; receiving, from the user device of the user, a registration request for the collectible product, wherein the registration request includes a third image of the collectible product in combination with the grading indicia; and registering the collectible product to a database using the grading indicia

### CROSS-REFERENCE TO RELATED APPLICATIONS

N/A

### FIELD OF THE INVENTION

The present technology is directed to systems and methods for analyzing a collectible product based on a plurality of factors that include, but are not limited to, images of the collectible product, user-provided information regarding the collectible product, and the like. Various grading processes can be used that include machine learning-based grading, along with professional, manual grading. Some embodiments include capturing images of the collectible product in combination with grading indicia, such as an adhesive holographic image. Images of the collectible product can be obtained before and after sealing the collectible product in a protective enclosure, which can be sealed with the adhesive holographic image. The collectible product can be registered to a database for cataloging.

### SUMMARY

According to some embodiments, the present technology is directed to a method that may comprise receiving, from a user device of a user, a grading request to obtain a grade for a collectible product having a first surface and a second surface, the grading request comprising a first image of the first surface and a second image of a second surface; determining the grade for the collectible product; generating grading indicia for the collectible product that includes the grade; causing the grading indicia to be mailed to the user; receiving, from the user device of the user, a registration request for the collectible product, wherein the registration request includes a third image of the collectible product in combination with the grading indicia; and registering the collectible product to a database using the grading indicia.

In some embodiments, the present disclosure is directed to a system of one or more computers which can be configured to perform particular operations or actions by virtue of having software, firmware, hardware, or a combination of these installed on the system that in operation causes or cause the system to perform the actions and/or method steps described herein. An example system can comprise a processor; and a memory, the processor executing instructions stored in the memory to receive a grading request to obtain a grade for a collectible product having a first surface and a second surface, the grading request comprising a first image of the first surface and a second image of a second surface; receive responses from a user grading feature, the responses provided by a user; generate a machine predicted grade for the collectible product using the first image, the second image, and the responses; obtain a professional grade for the collectible product; generate grading indicia for the collectible product, the grading indicia comprising the grade, the grade being based on the machine predicted grade and the professional grade; cause the grading indicia to be mailed to the user; receive a registration request for the collectible product, wherein the registration request includes a third image and a fourth image of the collectible product in combination with the grading indicia; and register the collectible product to a database with the first image, the second image, the third image, the fourth image, and the grading indicia.

In another embodiment, the present disclosure is directed to a method that may comprise generating, by a user device of a user, a grading request to obtain a grade for a collectible product having a first surface and a second surface, the grading request comprising a first image of the first surface and a second image of a second surface; providing a user grading feature to the user device to obtain responses from the user; receiving a machine predicted grade for the collectible product using the first image, the second image, and the responses; receiving a professional grade for the collectible product; receiving grading indicia for the collectible product, the grading indicia comprising the grade, the grade being based on the machine predicted grade and the professional grade; causing the grading indicia to be mailed to the user along with a protective enclosure; and generating, by the user device, a registration request to register the collectible product in a database.

In some embodiments, the present disclosure is directed to a non-transitory computer-readable storage medium having embodied thereon a program. The program is executable by a processor to provide a method, the method comprising generating, by a user device of a user, a grading request to obtain a grade for a collectible product having a first surface and a second surface, the grading request comprising a first image of the first surface and a second image of a second surface; providing a user grading feature to the user device to obtain responses from the user; receiving a machine predicted grade for the collectible product using the first image, the second image, and the responses; receiving a professional grade for the collectible product; receiving grading indicia for the collectible product, the grading indicia comprising the grade, the grade being based on the machine predicted grade and the professional grade; causing the grading indicia to be mailed to the user along with a protective enclosure; and generating, by the user device, a registration request for the collectible product, wherein the registration request includes a third image and a fourth image of the collectible product in combination with the grading indicia, wherein the collectible product is registered to a database with the first image, the second image, the third image, the fourth image, and the grading indicia.

The systems and methods disclosed herein can be embodied in a means for arrangement and/or steps for configurations in some embodiments. Additionally, the methods described herein can be embodied on a non-transitory computer-readable medium that can be executed by a computing device.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 depicts an illustrative architecture in which techniques and structures for providing the systems and methods disclosed herein may be implemented.

FIG. 2 depicts another example illustrative architecture in which techniques and structures for providing the systems and methods disclosed herein may be implemented.

FIGS. 3A-3N collectively illustrates various graphical user interfaces that allow a user to utilize the collectible product grading and analysis systems disclosed herein.

FIG. 4 is a flowchart of an example method of the present disclosure.

FIG. 5 is a flowchart of another example method of the present disclosure.

FIG. 6 is an example computing device that can be used to practice aspects of the present technology.

### DETAILED DESCRIPTION

Generally, the present disclosure pertains to systems and methods for analyzing collectible products. Example collectible products can include but are not limited to, a document, a comic book, a stamp, a photograph, and a document comprising a signature—just to name a few. Broadly, any collectible product for which a user can obtain images thereof can be graded in accordance with the present disclosure.

Some embodiments utilize interactive features where a user, such as an owner of a collectible product can utilize an end-user application installed on an end-user device to obtain images of the collectible product. The user can utilize an imaging system, such as a camera associated with a mobile device or user computer to obtain images of the collectible product. The imaging system could include a scanner or photocopier.

In addition to obtaining images of the collectible product, the user can also interact with a user grading feature, such as a questionnaire or chat function mediated through graphical user interfaces (GUI) provided through the mobile device or user computer. In some embodiments, the chat or questionnaire can be prepared by a subject matter expert, such as a professional grader with expertise in a domain of the collectible product. For example, if the collectible product is a baseball card, the professional grader can provide questions to the user through a chat function or questionnaire. These questions elicit responses related to the quality of the collectible product, such as areas of visible damage. Other general information regarding attributes or provenance of the collectible product can be collected through the chat function or questionnaire. The chat function or questionnaire can be provided in an automated manner in some embodiments.

Based on any combination of images and/or responses provided by the user through the user grading feature, a machine predicted grade for the collectible product can be generated. This can be performed by a machine learning (ML) engine associated with a service provider.

In some instances, a second grading process can be utilized. For example, a manual, professional grading process can be utilized to generate a professional grade for the collectible product. In some embodiments, the professional grade for the collectible product is determined by a professional who inspects the images of the collectible product and consults the responses provided by the user (if included). In other embodiments, the professional grade for the collectible product is determined after the user has mailed the collectible product to the professional grader for physical inspection.

In some embodiments, the professional grade is obtained only after the user is consulted or queried regarding the machine predicted grade. Thus, the user can select whether or not to continue with professional grading based on the machine predicted grade. The user may choose not to perform the professional grading, or may instead choose to mail the collectible product to the professional for physical grading.

In some instances, a grade for the collectible product can be based on both the machine predicted grade and the professional grade. In some embodiments, when the collectible product has been graded either using the ML engine and/or based on a professional grade, the grade for the collectible product can be printed as grading indicia. The grading indicia can include a stamp or seal that can include holographic elements that identify both the collectible product and the grade. In some embodiments, the grading indicia include a tamper-proof, holographic seal. The collectible product can be tracked using a unique identifier that can be associated with the user/owner.

The grading indicia can be mailed to the user along with a protective enclosure. The user can place their collectible product into the protective enclosure, sealing the protective enclosure with the grading indicia.

The user can obtain additional images of the collectible product in its protective enclosure that was sealed with the grading indicia. The graded collectible product can be registered to a database using the grading indicia, along with the images obtained of the collectible product both when inside and outside of the protective enclosure. Interested parties can search the database and provide purchase offers to buy registered and graded collectible products, if offered for sale.

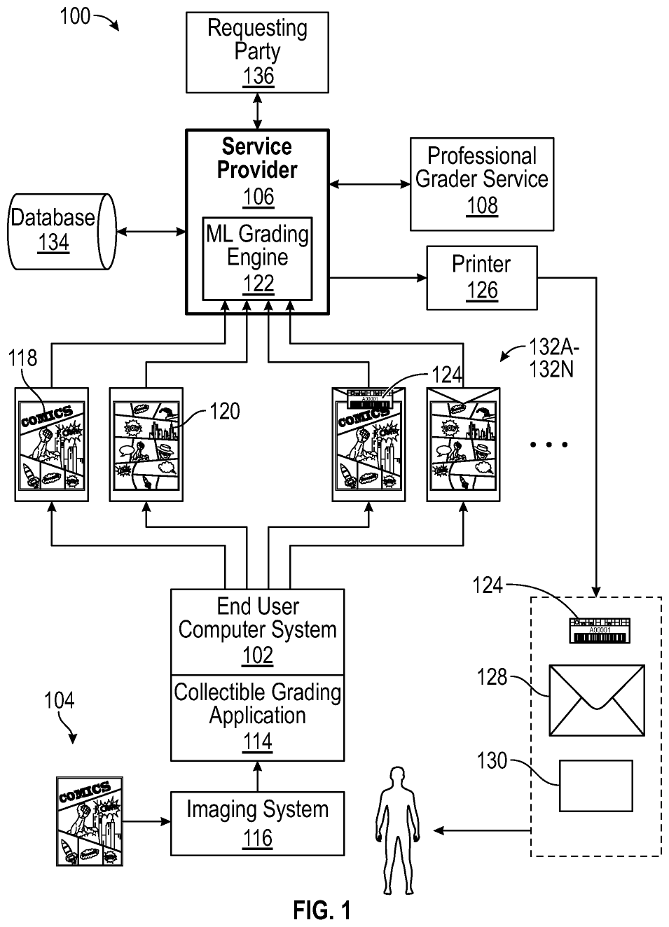

FIG. 1 depicts an illustrative architecture in which techniques and structures for providing the systems and methods disclosed herein may be implemented. The architecture 100 includes an end-user computing device 102, a collectible product 104, a service provider 106, and a professional grader service 108. Each of the components of the architecture can be communicatively coupled using a network. The network may include any one or a combination of multiple different types of networks, such as cable networks, the Internet, cellular networks, wireless networks, and other private and/or public networks. In some instances, the network may include cellular, Wi-Fi, or Wi-Fi direct. In other embodiments, components of the environment can communicate using short-range wireless protocols such as Bluetooth, near-field, infrared, and the like.

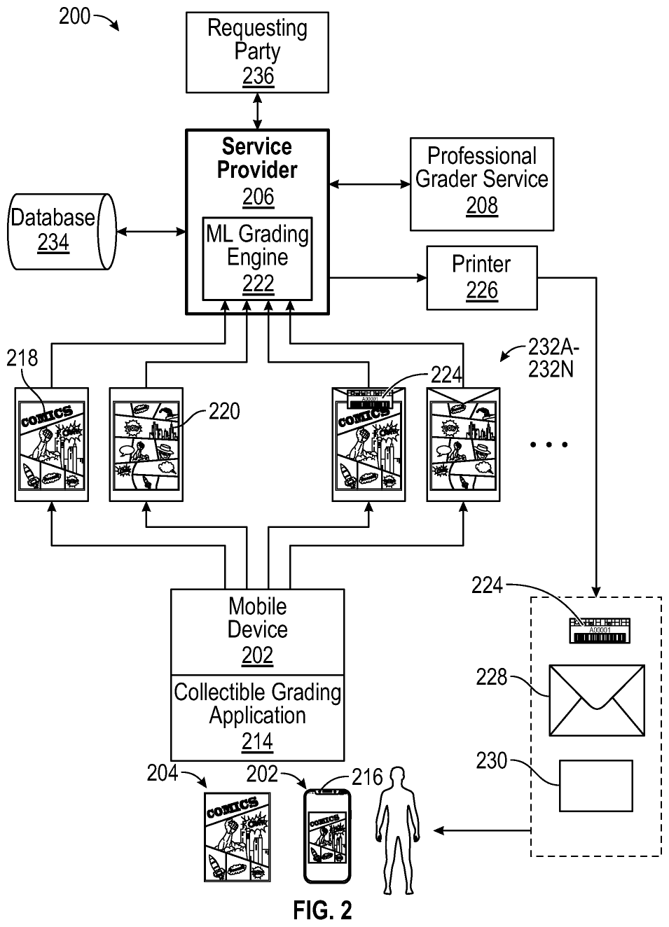

The end-user computing device 102 can include a personal computer, a laptop, a desktop, or another similar computing system/device. In other embodiments, such as the embodiment of FIG. 2, the end-user computing device 102 can include a mobile device having a built-in camera used to obtain images. In some embodiments, the end-user computing device 102 can execute a collectible grading application 114. In other embodiments, the end-user computing device 102 can access a collectible grading service (referred to as a ML grading engine) that can be provided at the service provider level. Generally, the collectible grading application or service may be provided as logic that is executable by a processor.

The end-user computing device 102 can be associated with an imaging system 116. In one embodiment, the imaging system 116 can include a camera or scanner (e.g., for instances where the collectible product is a document or has surfaces that can be scanned). The camera could be integrated into the end-user computing device 102 or a standalone camera that is communicatively coupled to the end-user computing device 102. Initially, the user can create a user record or account that is maintained at the service provider 106. The account can include a registered address for the user where materials may be mailed, as will be discussed in greater detail herein.

In general, the imaging system 116 can be used to obtain images of the collectible product 104. In some embodiments, the collectible product 104 includes an object having a first surface 118 and a second surface 120. The first surface 118 could include a front surface of the collectible product 104, while the second surface 120 could include a back surface of the collectible product 104. For example, when the collectible product 104 is a comic book, the first surface 118 could include a front cover of the comic book. The second surface 120 could include a back cover of the comic book. Other images can be obtained of individual pages or the spine of the comic book as well.

Once images of the collectible product 104 are obtained, the images can be forwarded to the service provider 106 for analysis and grading. In addition to images, the end-user computing device 102 can be configured to provide a user grading feature through a graphical user interface. Examples of a user grading feature could include a chat feature or a questionnaire. In one embodiment, the user grading feature can be automated and script-based. For example, a chatbot or script can pose a variety of questions to the user that are designed to elicit information from the user about the collectible product 104 that may influence the grading of the collectible product 104. The exact content of the questions can be based on the type of collectible product 104 being evaluated. In another embodiment, a questionnaire can be presented to the user. Responses to the questionnaire and/or the chat feature can be used by the service provider to generate a machine predicted grade for the collectible product 104.

Rather than being automated through the provision of scripted questions, a chat feature can be enabled when the end-user computing device 102 is communicatively coupled with the professional grader service 108 through the network. The chat feature can be used to allow a professional grader to pose questions to the user about the collectible product 104. These questions could be directed to subject matter that will assist the professional grader in generating a grade for the collectible product 104. The user can supply specific images of the collectible product 104 as requested by the professional grader that can be transferred through the chat feature or over the network.

In a first, machine-driven analysis, the images obtained by the end-user computing device 102 of the collectible product 104, as well as responses provided by the user to the user grading feature can be forwarded to the service provider 106 for analysis. As noted above, the service provider 106 can comprise a machine learning (ML) grading engine 122. Broadly, the ML grading engine 122 can be trained on images of collectible products. Over time and through iterative use, the ML grading engine 122 can be trained to evaluate and grade the collectible product 104 based on training data. The ML grading engine 122 can generate a machine predicted grade for the collectible product. The grading process is based on comparative analyses of features of the collectible product 104 in relation to trained data.

In some embodiments, the machine predicted grade for the collectible product can be presented back to the user of the end-user computing device 102 in a graphical user interface. The user can be queried as to whether they wish to continue with a professional grading of the collectible product 104. If the user so desires, a confirmation can be obtained at the end-user computing device 102 and relayed back to the service provider 106. In some instances, the service provider 106 can forward the request for a professional grading of the collectible product 104 to the professional grader service 108 through the network. A professional grader, using the professional grader service 108, can evaluate the images obtained by the end-user computing device 102, along with any user-provided information and generate a professional grade for the collectible product 104.

The service provider 106 can generate a grade for the collectible product 104 considers both the machine predicted grade and the professional grade. In one embodiment, the grade is an average of the machine predicted grade and the professional grade.

In various embodiments, the service provider 106 can generate grading indicia 124 for the collectible product 104. The grading indicia 124 could include a sticker or label that includes the grade (could include either or both of the machine predicted grade and the professional grade). The grading indicia 124 could include a seal with a holographic image printed thereon. The grading indicia 124 can function as an immutable or tamper-proof indicator that the collectible product 104 has been graded. In some instances, the grading indicia 124 can have an adhesive surface that seals the collectible product 104 in a protective enclosure, such as a transparent sleeve.

In one embodiment, the grading indicia 124 can be printed by a printer 126 associated with the service provider 106. This printer 126 could be co-located with the service provider 106 or associated with a third-party printing service.

The service provider 106 can cause the grading indicia 124 to be mailed (could be performed by a third party) to the user/owner of the collectible product 104. In addition to mailing the grading indicia 124, a protective enclosure 128, and reinforcement material 130 can also be mailed to the user/owner.

When the user receives these materials, the user can place the collectible product 104 into the protective enclosure 128. The reinforcement material 130 can be added, if desired to provide additional support and prevent folding or other deleterious damage to the collectible product 104. The reinforcement material could include a thin, transparent sheet of non-reactive plastic. The user can seal the collectible product 104 into the protective enclosure 128 using the grading indicia 124.

Once sealed, the user can obtain additional images of the collectible product 104 sealed in the protective enclosure 128 with the grading indicia 124. The user can utilize the end-user computing device 102 along with the imaging system 116 to obtain these additional images 132A-132N. These additional images 132A-132N can be transmitted to the service provider 106. For example, the user can transmit a registration request from the end-user computing device 102 to the service provider 106 to register the collectible product 104 that has been graded.

The registration of the collectible product 104 can be based on the additional images 132A-132N that include the collectible product 104 that has been sealed in the protective enclosure 128 using the grading indicia 124. If the additional images 132A-132N are verified, the collectible product 104 can be registered in a database 134. In addition to registration, the database can store the various images obtained by the end-user computing device 102 in association with the grading indicia 124. The database can be queried by a requesting party 136. The requesting party could submit a query for a particular type of collectible product. When the registered, collectible product 104 is responsive to the request, the service provider 106 can forward the requesting party 136 any combination of images and the grading indicia for the collectible product 104. The requesting party 136 can submit a purchase request for the collectible product 104. If the owner of the collectible product 104 accepts, the requesting party 136 can purchase the collectible product 104.

FIG. 2 depicts an illustrative architecture in which techniques and structures for providing the systems and methods disclosed herein may be implemented. The architecture 200 includes a mobile device 202, a collectible product 204, a service provider 206, a professional grader service 208, and a network. The network may include any one or a combination of multiple different types of networks, such as cable networks, the Internet, cellular networks, wireless networks, and other private and/or public networks. In some instances, the network may include cellular, Wi-Fi, or Wi-Fi direct. In other embodiments, components of the environment can communicate using short-range wireless protocols such as Bluetooth, near-field, infrared, and the like.

The mobile device 202 can comprise a built-in camera that is used to obtain images of the collectible product 204. Generally, the mobile device 202 can install and execute a collectible grading application 214. The collectible grading application 214 installed on the mobile device 202 can cooperate with a collectible grading service collectible grading service (referred to as a ML grading engine) provided at the service provider level. Generally, the collectible grading application or service may be provided as logic that is executable by a processor.

The mobile device 202 can be associated comprise a camera 216. The camera could be integrated into the mobile device 202 or a standalone camera that is communicatively coupled to the mobile device 202.

In general, the camera 216 can be used to obtain images of the collectible product 204. In some embodiments, the collectible product 104 includes an object having a first surface 218 and a second surface 220. The first surface 218 could include a front surface of the collectible product 204, while the second surface 220 could include a back surface of the collectible product 204. For example, when the collectible product 204 is a comic book, the first surface 218 could include a front cover of the comic book. The second surface 220 could include a back cover of the comic book. Other images can be obtained of individual pages or the spine of the comic book as well.

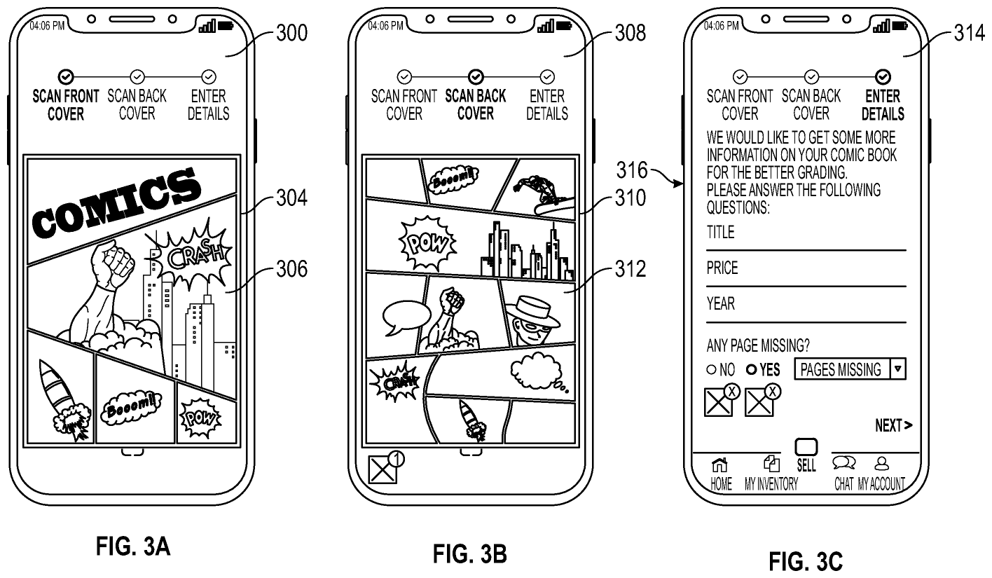

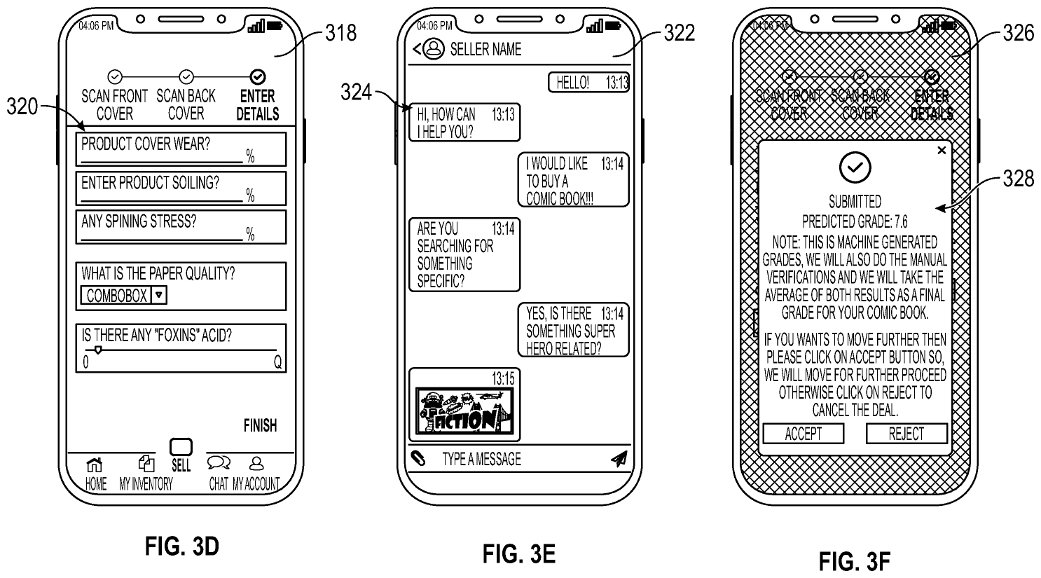

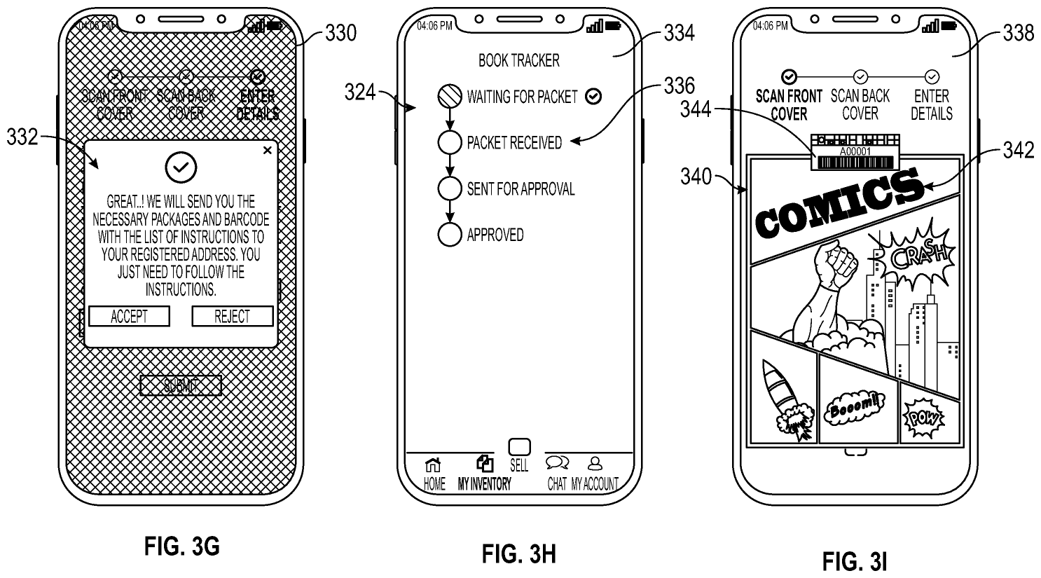

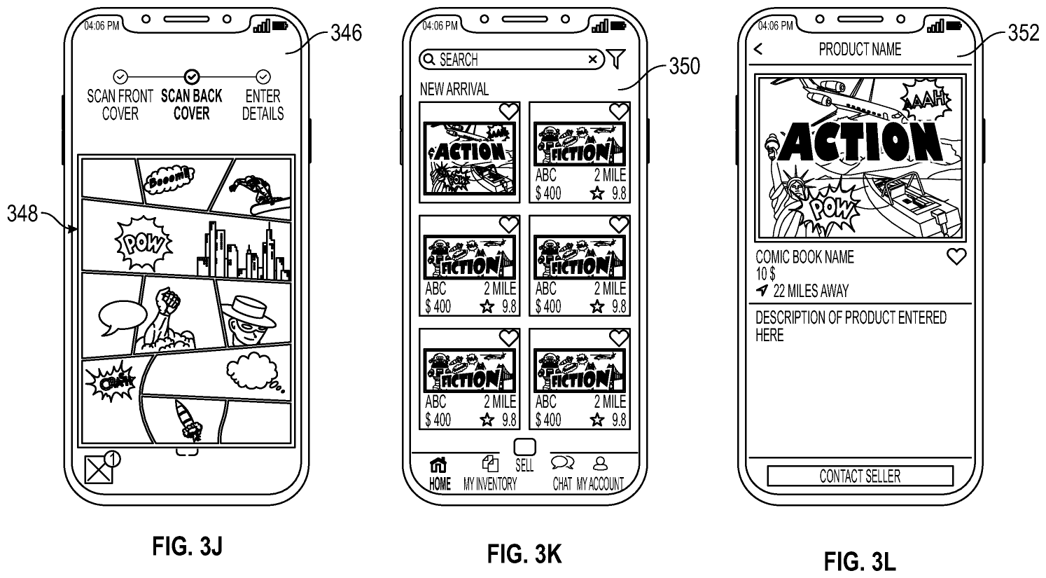

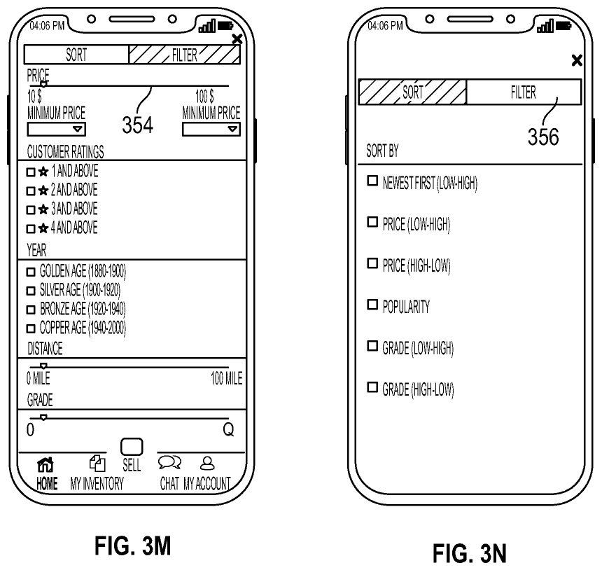

Once images of the collectible product 204 are obtained, the images can be forwarded by the mobile device 202 (through the collectible grading application 214) to the service provider 206 for analysis and grading. In addition to images, the collectible grading application 214 of the mobile device 202 can be configured to provide a user grading feature through a graphical user interface. Example graphical user interfaces generated and displayed by the collectible grading application 214 are included in FIGS. 3A-3L, which are described in greater detail infra.

Examples of a user grading feature could include a chat feature or a questionnaire. In one embodiment, the user grading feature can be automated and script-based. For example, a chatbot or script can pose a variety of questions to the user that are designed to elicit information from the user about the collectible product 204 that may influence grading of the collectible product 204. The exact content of the questions can be based on the type of collectible product 204 being evaluated. In another embodiment, a questionnaire can be presented to the user. Responses to the questionnaire and/or the chat feature can be used by the service provider to generate a machine predicted grade for the collectible product 204.

Rather than being automated, a chat feature can be enabled when the mobile device 202 is communicatively coupled with the professional grader service 208 through the network. The chat feature can be used to allow a professional grader to pose questions to the user about the collectible product 204. These questions could be directed to subject matter that will assist the professional grader in generating a grade for the collectible product 204. The user can supply specific images of the collectible product 204 as requested by the professional grader that can be transferred through the chat feature or over the network.

In a first, machine-driven analysis, the images obtained by the mobile device 202 of the collectible product 204, as well as responses provided by the user to the user grading feature can be forwarded to the service provider 206 for analysis. As noted above, the service provider 206 can comprise machine learning (ML) grading engine 222. Broadly, the ML grading engine 222 can be trained on images of collectible products. Over time and through iterative use, the ML grading engine 222 can be trained to evaluate and grade the collectible product 204 based on training data. The ML grading engine 222 can generate a machine predicted grade for the collectible product. The grading process is based on comparative analyses of features of the collectible product 204 in relation to trained data.

In some embodiments, the machine predicted grade for the collectible product can be presented back to the user of the mobile device 202 in a graphical user interface. The user can be queried as to whether they wish to continue with a professional grading of the collectible product 204. If the user so desires, a confirmation can be obtained at the mobile device 202 and relayed back to the service provider 206. In some instances, the service provider 206 can forward the request for a professional grading of the collectible product 204 to the professional grader service 108 through the network. A professional grader, using the professional grader service 208, can evaluate the images obtained by the mobile device 202, along with any user-provided information and generate a professional grade for the collectible product 204.

The service provider 206 can generate a grade for the collectible product 104 considers both the machine predicted grade and the professional grade. In one embodiment, the grade is an average of the machine predicted grade and the professional grade.

In various embodiments, the service provider 206 can generate grading indicia 224 for the collectible product 204. The grading indicia 224 could include a sticker or label that includes the grade (could include either or both of the machine predicted grade and the professional grade). The grading indicia 224 could include a seal with a holographic image printed thereon. The grading indicia 224 can function as an immutable or tamper-proof indicator that the collectible product 204 has been graded.

In one embodiment, the grading indicia 124 can be printed by a printer 226 associated with the service provider 206. This printer 226 could be co-located with the service provider 206 or associated with a third-party printing service. The service provider 206 can cause the grading indicia 224 to be mailed (could be performed by a third party) to the user/owner of the collectible product 204. In addition to mailing the grading indicia 224, a protective enclosure 228, and reinforcement material 230 can also be mailed to the user/owner.

When the user receives these materials, the user can place the collectible product 204 into the protective enclosure 228. The reinforcement material 230 can be added, if desired to provide additional support and prevent folding or other deleterious damage to the collectible product 204. The user can seal the collectible product 204 into the protective enclosure 228 using the grading indicia 224.

Once sealed, the user can obtain additional images of the collectible product 204 sealed in the protective enclosure 228 with the grading indicia 224. The user can utilize the mobile device 202 that includes the camera 216 to obtain these additional images 232A-232N. These additional images 232A-232N can be transmitted to the service provider 106. For example, the user can transmit a registration request from the mobile device 202 to the service provider 206 to register the collectible product 204 that has been graded.

The registration of the collectible product 204 can be based on the additional images 232A-232N that include the collectible product 204 that has been sealed in the protective enclosure 228 using the grading indicia 224. If the additional images 232A-232N are verified, the collectible product 204 can be registered in a database 234. In addition to registration, the database can store the various images obtained by the end-user computing device 202 in association with the grading indicia 224. The database can be queried by a requesting party 236. The requesting party could submit a query for a particular type of collectible product. When the registered, collectible product 204 is responsive to the request, the service provider 206 can forward the requesting party 236 any combination of images and the grading indicia for the collectible product 204. The requesting party 236 can submit a purchase request for the collectible product 204. If the owner of the collectible product 204 accepts, the requesting party 236 can purchase the collectible product 204.

FIGS. 3A-3N collectively illustrates various graphical user interfaces (GUIs) provided by a collectible grading application or service. For example, these GUIs can be generated and displayed by an application residing on a mobile device or other end-user computing device. The GUIs could also be generated by a service provider.

FIG. 3A illustrates a GUI 300 that includes an image 304 of a collectible product 306. The image 304 is of a front cover of a comic book. FIG. 3B illustrates a GUI 308 that includes an image 310 of a collectible product 312, such as a back cover of a comic book. The image 310 is of a front cover of a comic book. FIG. 3C illustrates a GUI 314 that includes a series or set of data fields 316 that receive information regarding the collectible product 312 such as title, price, year, and so forth. Basic questionnaire requests can be included where a user can indicate if pages of the comic book are missing. FIG. 3D illustrates a GUI 318 that includes additional questionnaire fields 320 that are directed to eliciting specific information regarding the collectible product such as cover wear, product soiling, paper quality, and so forth. These fields can be selected based on the type of collectible product selected and imaged.

FIG. 3E illustrates a GUI 322 that includes a chat feature 324 where a professional grader or other data gathering party can communicate with the collectible product owner to obtain information about the collectible product. Once the images have been uploaded and any information obtained using the questionnaire and/or the chat feature, the service provider can process the images and information to generate a machine predicted grade. Generally, the chat feature 324 allows for free exchange of communications and information between any two or more parties related to the collectible product. As noted, this can include information exchanged between a professional grader and an end user. Another example includes communications and information exchanged between a first professional grader and a second professional grader, where the first professional grader can obtain a professional opinion from the second professional grader.

FIG. 3F illustrates a GUI 326 that includes an example machine predicted grade 328. GUI 326 includes selectable elements that request if a user is interested in obtaining a professional grade for their collectible product. Stated otherwise, the request is used to determine if the user desires to obtain the professional grade for the collectible product. If the user selects to obtain the professional grade for their collectible product, a message is transmitted to the service provider that initiates a process where the collectible product is assigned a professional grade. As noted above, the professional grade can be based on a professional grader reviewing the images and questionnaire/chat information. The professional grade can be based on a professional grader physically reviewing the collectible product.

FIG. 3G illustrates a GUI 330 that includes a confirmatory message 332 indicating that the user has selected to have a professional grade assigned to their collectible product. FIG. 3H illustrates a GUI 334 that includes a real-time updated timeline 336 that tracks the status of both mailed elements and collectible product approval. For example, once the user desires to obtain a professional grade, once the professional grade is determined, the grading indicia and protective enclosure are mailed to the user. The mailing and/or receipt of this content can be reflected on the timeline 336. Approval elements on the timeline 336 relate to when the collectible product has been sealed in a protective enclosure with the grading indicia and additional images of the collectible product in its sealed configuration have been received and approved by the service provider.

FIG. 3I illustrates a GUI 338 that includes an image 340 of a front cover of the comic book. The comic book has been sealed in a protective enclosure 342. Grading indicia 344 is captured in the image 340. FIG. 3J illustrates a GUI 346 that includes an image 348 of a back cover of the comic book in the protective enclosure 342. Once these additional images that include the grading indicia have been received by the service provider, the collectible product can be approved for registration and listing for sale in some embodiments. The approval process can include verifying data of the grading indicia. As noted above, the grading indicia can encode or store information such as a quick response (QR) code, barcode, holographic image, and the like that can be used to encode information. In some instances, textual content can be provided on the grading indicia rather than (or in addition to) encoded data.

FIG. 3K illustrates a GUI 350 that includes a plurality of items for sale that have been graded, approved, and listed for sale. FIG. 3L illustrates a GUI 352 that illustrates an image and descriptive data regarding a collectible product. FIG. 3M illustrates a GUI 354 that includes filtering criteria for searching for collectible products. FIG. 3N illustrates a GUI 356 that includes additional filtering criteria for searching for collectible products.

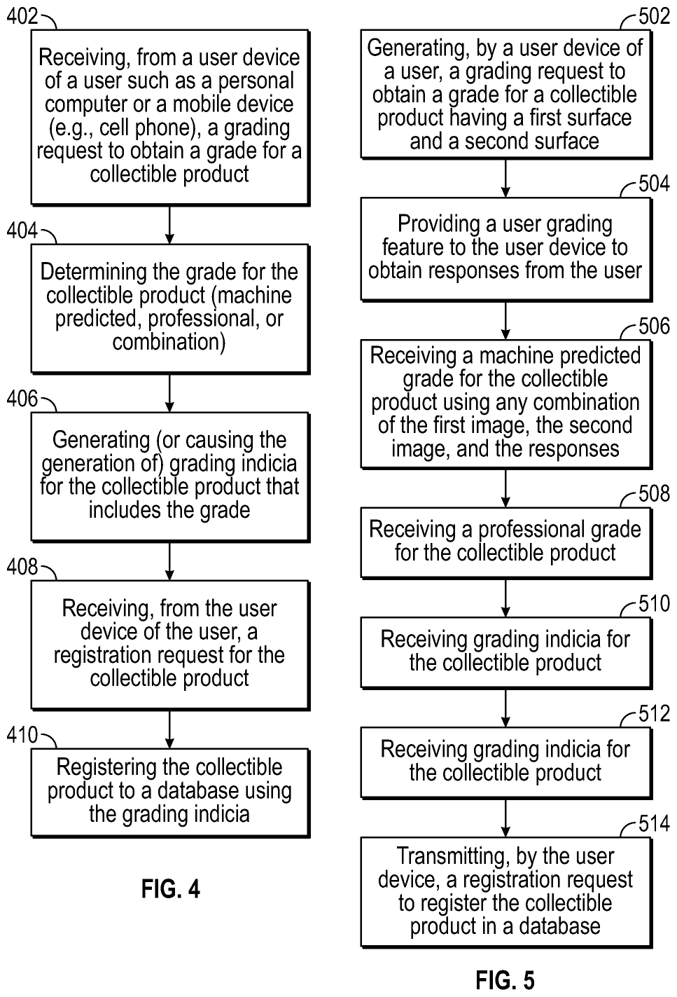

FIG. 4 is a flowchart of an example method of the present disclosure. The method can be performed by a service provider, for example. The method can include a step 402 of receiving, from a user device of a user such as a personal computer or a mobile device (e.g., cell phone), a grading request to obtain a grade for a collectible product. In some embodiments, the collectible product can have a first surface and a second surface, such as a comic book or baseball card. The request can include a first image of the first surface and a second image of a second surface of the collectible product.

In response to the request, the method can include a step 404 of determining the grade for the collectible product. In some instances, the grade could include a machine predicted grade, a professional grade, or a combined grade calculated using both the machine predicted grade and the professional grade. In some embodiments, the grade of the collectible product can be determined using not only the images of the collectible product but also response to questions posed to an owner of the collectible product through a chat session or a questionnaire.

The method can include a step 406 of generating grading indicia for the collectible product that includes the grade. The grading indicia can include any grading indicia such as a barcode, QR code, text, a holographic image, and so forth. The method can include a step of causing a protective cover to be mailed to the user along with the grading indicia. The grading indicia can comprise a holographic sticker.

The method can include a step 408 of receiving, from the user device of the user, a registration request for the collectible product. The registration request includes at least a third image of the collectible product in combination with the grading indicia. For example, when the user receives the grading indicia, the user can place the collectible product in a protective enclosure and seal the collectible product in the protective enclosure using the grading indicia. The third image is taken of the collectible product sealed in the collectible product. The image includes the grading indicia.

The third image can be of the first surface of the collectible product after it is placed into the protective cover. The protective cover can be sealed using the holographic sticker.

Once the third image has been approved, the method can include a step 410 of registering the collectible product to a database using the grading indicia. The registration request can include additional images in some instances. The registered collectible product can be published for sale on a website or through an application or service provided by the service provider.

FIG. 5 is another flowchart of an example method of the present disclosure. The method can include a step 502 of generating, by a user device of a user, a grading request to obtain a grade for a collectible product having a first surface and a second surface. In some embodiments, the grading request can comprise a first image of the first surface and a second image of a second surface of the collectible product.

In some embodiments, the method can include a step 504 of providing a user grading feature to the user device to obtain responses from the user. As noted above, this can include a chat feature/session or a questionnaire. The method can include a step 506 of receiving a machine predicted grade for the collectible product using any combination of the first image, the second image, and the responses. In some embodiments, the method can include a step 508 of receiving a professional grade for the collectible product.

The method can include a step 510 of professional grade for the collectible product. In some embodiments, the machine predicted grade can be presented to a user through a graphical user interface displayed on the user device. The user can select whether they desire to obtain the professional grade for the collectible product. The professional grade may be obtained in response to this selection by the user.

As noted above, the grading indicia can comprise the grade determined for the collectible product. The grade can be based on the machine predicted grade and the professional grade.

The method can include a step 512 of receiving grading indicia for the collectible product. As noted above, the grading indicia can comprise a grade that is based on the machine predicted grade and the professional grade. In some instances, the method can include a step 514 of transmitting, by the user device, a registration request to register the collectible product in a database. The collectible product can be registered to the database using any combination of the first image, the second image, the third image, a fourth image of the second surface of the collectible product in combination with the grading indicia, and the grading indicia.

In various embodiments, the collectible product analysis, grading, and sales features disclosed herein can be offered to users, both owners and collectible purchasers (e.g., requesting parties noted above) for a fee. Users can be charged a service fee to utilize the collectible product analysis, grading, and sales features. In other embodiments, the users can be charged on a per-transaction basis.

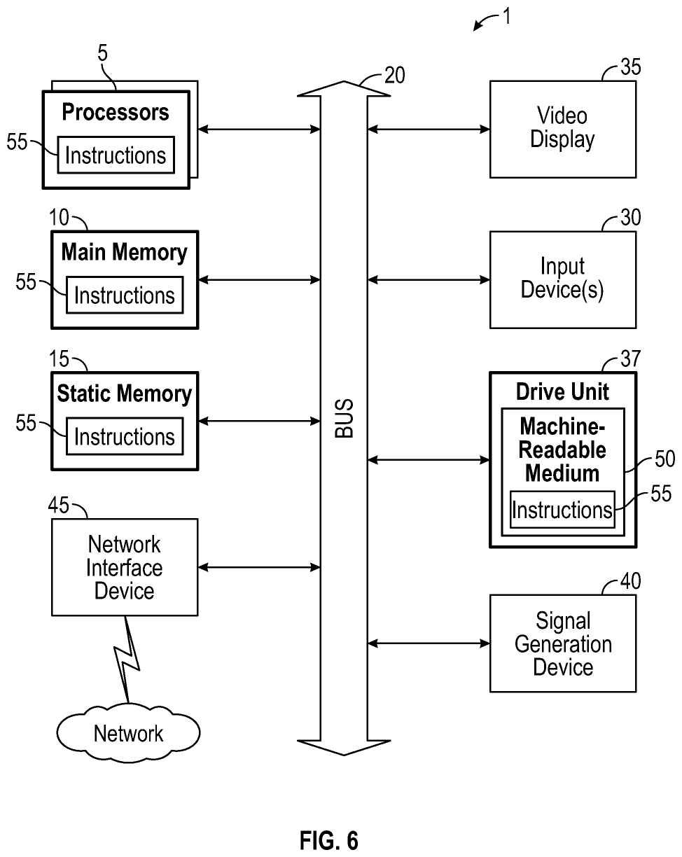

FIG. 6 is a diagrammatic representation of an embodiment of a machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a robotic construction marking device, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The embodiment of the computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. The description herein is illustrative and not restrictive. Many variations of the technology will become apparent to those of skill in the art upon review of this disclosure.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method, comprising:
receiving, from a user device of a user, a grading request to obtain a grade for a collectible product having a first surface and a second surface, the grading request comprising a first image of the first surface and a second image of a second surface;
determining the grade for the collectible product;
generating grading indicia for the collectible product that includes the grade;
causing the grading indicia to be mailed to the user;
receiving, from the user device of the user, a registration request for the collectible product, wherein the registration request includes a third image of the collectible product in combination with the grading indicia; and
registering the collectible product to a database using the grading indicia.

2. The method according to claim 1, further comprising causing a protective cover to be mailed to the user along with the grading indicia, wherein the grading indicia comprises a holographic sticker.

3. The method according to claim 2, wherein the third image is of the first surface of the collectible product after it is placed into the protective cover, wherein the protective cover is sealed using the holographic sticker.

4. The method according to claim 3, wherein the registration request comprises a fourth image of the second surface of the collectible product after it is placed into the protective cover.

5. The method according to claim 1, wherein determining the grade for the collectible product comprises:
providing a user grading feature to the user device to obtain responses from the user regarding the collectible product; and
receiving responses based on the user grading feature.

6. The method according to claim 5, further comprising generating a machine predicted grade for the collectible product based on the responses, the first image, and the second image.

7. The method according to claim 6, further comprising determining the grade for the collectible product using the machine predicted grade and a professional grade.

8. A method, comprising:
generating, by a user device of a user, a grading request to obtain a grade for a collectible product having a first surface and a second surface, the grading request comprising a first image of the first surface and a second image of a second surface;
providing a user grading feature to the user device to obtain responses from the user;
receiving a machine predicted grade for the collectible product using the first image, the second image, and the responses;
receiving a professional grade for the collectible product;
receiving grading indicia for the collectible product, the grading indicia comprising the grade, the grade being based on the machine predicted grade and the professional grade; and
transmitting, by the user device, a registration request to register the collectible product in a database.

9. The method according to claim 8, further comprising obtaining a third image of the first surface of the collectible product in combination with the grading indicia.

10. The method according to claim 9, wherein the collectible product is registered to the database using any combination of the first image, the second image, the third image, a fourth image of the second surface of the collectible product in combination with the grading indicia, and the grading indicia.

11. The method according to claim 10, further comprising:
receiving a request for the collectible product from a requesting party; and
providing a response to the requesting party that includes the first image, the second image, the third image, the fourth image, and the grading indicia.

12. The method according to claim 11, wherein the request includes a purchase offer for the collectible product from the requesting party.

13. The method according to claim 8, further comprising causing the grading indicia to be mailed to the user along with a protective enclosure.

14. The method according to claim 8, further comprising:
causing presentation of the machine predicted grade on a graphical user interface of the user device; and
causing presentation of a request on the graphical user interface, wherein the request is used to determine if the user desires to obtain the professional grade for the collectible product.

15. A system, comprising:
a processor; and
a memory, the processor executing instructions stored in the memory to:
receive a grading request to obtain a grade for a collectible product having a first surface and a second surface, the grading request comprising a first image of the first surface and a second image of a second surface;
receive responses from a user grading feature, the responses provided by a user;
generate a machine predicted grade for the collectible product using the first image, the second image, and the responses;
obtain a professional grade for the collectible product;
generate grading indicia for the collectible product, the grading indicia comprising the grade, the grade being based on the machine predicted grade and the professional grade;
causing the grading indicia to be mailed to the user;
receive a registration request for the collectible product, wherein the registration request includes a third image and a fourth image of the collectible product in combination with the grading indicia; and
register the collectible product to a database with the first image, the second image, the third image, the fourth image, and the grading indicia.

16. The system according to claim 15, further comprising a printer capable of printing the grading indicia as a holographic image.

17. The system according to claim 15, wherein the grading indicia comprises holographic image having an adhesive surface.

18. The system according to claim 17, wherein the collectible product is placed into a protective package and sealed using the holographic image.

19. The system according to claim 15, further comprising a machine learning engine that generates the machine predicted grade.

20. The system according to claim 15, wherein the collectible product includes any of a document, a comic book, a stamp, a photograph, and a document comprising a signature.

21. A non-transitory computer readable storage medium having embodied thereon a program, the program being executable by a processor to provide a method, the method comprising:
generating, by a user device of a user, a grading request to obtain a grade for a collectible product having a first surface and a second surface, the grading request comprising a first image of the first surface and a second image of a second surface;
providing a user grading feature to the user device to obtain responses from the user;
receiving a machine predicted grade for the collectible product using the first image, the second image, and the responses;
receiving a professional grade for the collectible product;
receiving grading indicia for the collectible product, the grading indicia comprising the grade, the grade being based on the machine predicted grade and the professional grade;
causing the grading indicia to be mailed to the user along with a protective enclosure; and
generating, by the user device, a registration request for the collectible product, wherein the registration request includes a third image and a fourth image of the collectible product in combination with the grading indicia, wherein the collectible product is registered to a database with the first image, the second image, the third image, the fourth image, and the grading indicia.

22. The non-transitory computer readable storage medium according to claim 21, the method further comprising:
causing presentation of the machine predicted grade on a graphical user interface of the user device; and
causing presentation of a request on the graphical user interface, wherein the request is used to determine if the user desires to obtain the professional grade for the collectible product.

23. The non-transitory computer readable storage medium according to claim 21, wherein the third image includes either the first surface or the second surface of the collectible product and the grading indicia.

24. The non-transitory computer readable storage medium according to claim 21, the method further comprising:
registering the collectible product to a database based on the third image and the fourth image;
receiving a request for the collectible product from a requesting party; and
providing a response to the requesting party that includes the first image, the second image, the third image, the fourth image, and the grading indicia.
